(19) United States
(12) Patent Application Publication
(10) Pub. No.: US 2002/0176443 A1
(43) Pub. Date: Nov. 28, 2002

(54) Method and apparatus for bandwidth management of TCP traffic employing post-acknowledgement control

(75) Inventors: Huan-Yun Wei, Hsinchu (TW); Ying-Dar Lin, Hsinchu (TW); Shih-Chiang Tsao, Hsinchu (TW)

Correspondence Address: Robert H. Chen, c/o BAKER & McKENZIE, 29th Floor, 805 Third Avenue, New York, NY, 10022, US

(73) Assignee: Accton Technology Corporation

(21) Appl. No.: 10/152,165

(22) Filed: May 22, 2002

(30) Foreign Application Priority Data
May 25, 2001 (TW) 90112687

(51) Int. Cl. H04J 3/14; H04L 1/00

(52) U.S. Cl. 370/468; 370/229

(57) ABSTRACT

An apparatus for bandwidth management of TCP traffic on a communications network that apparatus comprises a forward data controller, a backward Ack controller, and a post-acknowledgement control machine. The forward data controller has a queuing space of a plurality of buffer registers for queuing outbound data of the TCP traffic. The backward Ack controller has a plurality of queues each having a plurality of buffer registers for queuing inbound Acks of the TCP traffic. The post-acknowledgement control machine includes an Ack-pacing controller for controlling the queuing of the backward Ack controller. The Ack-pacing controller subsequently allows the release of each of the inbound Acks queued in backward Ack buckets of the backward Ack controller to the sender of the outbound data upon determining that the queues in the forward data controller is at least partially emptied by sending the queued outbound data to the receiver of the outbound data.

### FIELD OF THE INVENTION

This invention relates in general to bandwidth management for TCP (Transmission Control Protocol) communication channels and, in particular, to a method and an apparatus for implementing bandwidth management of TCP traffic utilizing post-acknowledgement control.

### BACKGROUND OF THE INVENTION

The Internet has become more and more important in many aspects of our daily life. As a result, adverse communication traffic conditions over the Net conveying multi-varied information for all types of World Wide Web access applications have become issues of great concern. In the corporate environment, this concern is particularly highlighted since high-speed communication links to the Net are typically very expensive to operate and are further frequently congested. For cost and convenience reasons, the communication links should be utilized at the maximum possible efficiency.

Since most traffic on the Internet is carried utilizing Transmission Control Protocol (TCP), efforts aimed at the improving network traffic management for providing more efficient bandwidth utilization have so far been concentrated on TCP-related issues. Many of the available commercial bandwidth management devices installed at the edge of corporate networks for enforcing network policies are based on the queuing technique. Currently, most enterprise network edge bandwidth management hardware and software products employ pure TCP-unaware schedulers in the forward, or outgoing, direction. Others incorporate TCP-aware add-on modules to control the behavior of TCP sources actively. Some of them claim to be able to optimize TCP flows via actively altering the window sizes in the backward acknowledgements and returning these Acks with precise timing.

In a sense, TCP-unaware scheduling is simple queuing that relies on the scheduler to determine which of the queue to send its queued packets based on preset queuing schemes. On the other hand, TCP-aware add-ons employ active adjustment of transmission based on parameters that reflect traffic conditions.

For bandwidth management, a general TCP-unaware packet scheduler is typically required because of User Datagram Protocol (UDP) requirements. Currently, most bandwidth policies adopted in the corporate arena are class-based; meaning sets of data flows are grouped in classes of queues according to predetermined criteria (flow classification). A large number of flows may be contained within each class (i.e., queue). However, multiple TCP flows sharing the same queue in a scheduler inevitably incur the need for a large buffer in an edge device due to mismatches between TCP window and Bandwidth-Delay Product (BDP) of the network. Large buffers result in large latencies as well as frequent overflows. The result is long waiting times for packets in queues of these schedulers before they can be sent over the network. Further, the issue of fairness among TCP flows with heterogeneous Round-Trip Times (RTTs) competing in the same queue still remains unresolved. Large buffer and latency requirements are caused, as mentioned, by mismatch between sender TCP window size and BDP, but the fairness issue is raised by the very nature of TCP itself.

In order to resolve these problems, some proposed TCP-aware schemes attempt to optimize TCP flows based on two major schemes. The first, a scheme known as window-sizing, involves approaching to the BDP of a TCP flow calculated based on the measurement of its RTT and then adjusting window size in TCP Acks. The second scheme implements pacing of Acks that releases the backward Acks at precise timing and is generally known as Ack-pacing. The category of TCP Rate Control techniques employing these two adjustment schemes is frequently referred to as TCR. A few commercially available products based on this TCR technique include PacketShaper by Packeteer, Inc. of California, QoSWorks by Sitara Networks, Inc. of Massachusetts, NetEnforcer by Allot Communications of California, WiseWan by NetReality of California, GuidanPro by NetGuard, Inc. of Texas, all of U.S.A., and IPolicer by Acute Communications Corporation of Hsinchu, Taiwan.

These queuing-based TCP-aware optimization schemes, however, suffer at least a couple of drawbacks that are not generally known. First, due to shrinking of window sizes, they perform less efficiently than pure queuing-based schemes (i.e., TCP-unaware ones) whenever there is an occasion of packet loss. Secondly, effectiveness of control over TCP senders varies under different operation systems because each operating system has its own different implementation tricks such as retransmit timers. In other words, performance characteristics of these Ack control modules are sender OS-dependent.

### SUMMARY OF THE INVENTION

It is therefore an object of the present invention to provide a method and an apparatus for bandwidth management of TCP traffic employing post-acknowledgement control that is less prone to efficiency degradation due to Internet packet loss conditions.

It is another object of the present invention to provide a method and an apparatus for bandwidth management of TCP traffic employing post-acknowledgement control that performs efficiently independent of the operating system employed.

It is still another object of the present invention to provide a method and apparatus for bandwidth management of TCP traffic employing post-acknowledgement control that requires far less buffer space for data queuing.

It is yet another object of the present invention to provide a method and apparatus for bandwidth management of TCP traffic employing post-acknowledgement control that exhibits reduced buffer latencies.

The present invention achieves the above and other objects by providing an apparatus for bandwidth management of TCP traffic on a communications network, the apparatus comprising a forward data controller, a backward Ack controller, and a post-acknowledgement control machine. The forward data controller has at least one queuing space having a plurality of buffer registers for queuing outbound data of the TCP traffic. The backward Ack controller has a plurality of queues each having a plurality of buffer registers for queuing inbound Acks of the TCP traffic. The post-acknowledgement control machine includes an Ack-pacing controller for controlling the orderly-pacing of the release of the packets queued. The Ack-pacing controller subsequently allows the release of each of the inbound Acks queued in the backward Ack controller to the sender of the outbound data upon determining that the queuing space in the forward data controller is at least partially emptied by sending the queued outbound data to the receiver of the outbound data.

The present invention further provides a method for bandwidth management of TCP traffic comprising the steps of first queuing the inbound Acks of the TCP traffic and subsequently releasing the inbound Acks back to the sender of the outbound data when its forward data queue is emptied at least partially and become not full.

### BRIEF DESCRIPTION OF THE DRAWINGS

Other objects, features, and advantages of the present invention will become apparent by way of the following detailed description of the preferred but non-limiting embodiments. The description is made with reference to the accompanied drawings in which:

FIG. 1 is a block diagram of a model schematically illustrating a typical TCP bandwidth management system according to the prior art;

FIG. 2 is a block diagram illustrating a model of a TCP bandwidth management system employing the conventional TCR scheme;

FIG. 3 is a block diagram illustrating a model of a TCP bandwidth management apparatus employing the post-acknowledgement control scheme in accordance with a preferred embodiment of the invention;

FIG. 4 is a state machine of the TCP bandwidth management apparatus of FIG. 3; and

FIG. 5 is a block diagram of an embodiment of the post-Ack control machine for implementing the post-acknowledgement control scheme of the bandwidth management apparatus of the invention.

### DETAILED DESCRIPTION OF THE INVENTION

The underlying spirit of the TCP design is the sharing of communication channels among all users in a cooperative manner. In general, a TCP transmitter restricts itself by reducing its own transmitting rate in half if packet loss signal over the channel is detected. This surrenders to others its channel bandwidth which is supposedly unusable by it since the packet loss might well have been caused by congestion.

Another TCP flow control mechanism allows a TCP receiver to declare and advise its unoccupied buffer size to the transmitter in its acknowledgement back to the sender. This helps to prevent the transmitter from overflowing the receiver's buffer. Such an overwhelmed buffer may cause packet loss for a transmission. In this mechanism, a TCP transmitter needs to maintain two window parameters W_{c} (congestion window) and Wᵣ (receiver-advertised window), which represent the maximum number of packets “allowed to be sent but not yet being acknowledged receipt” for the network and the receiver respectively. In order to satisfy the load capacity of both the network and the receiver simultaneously, the sender adopts the smaller value of the two parameters to set up its window which ultimately determines the instant flow rate. Although there are various TCP versions presently in operation, the basic characteristics are the same.

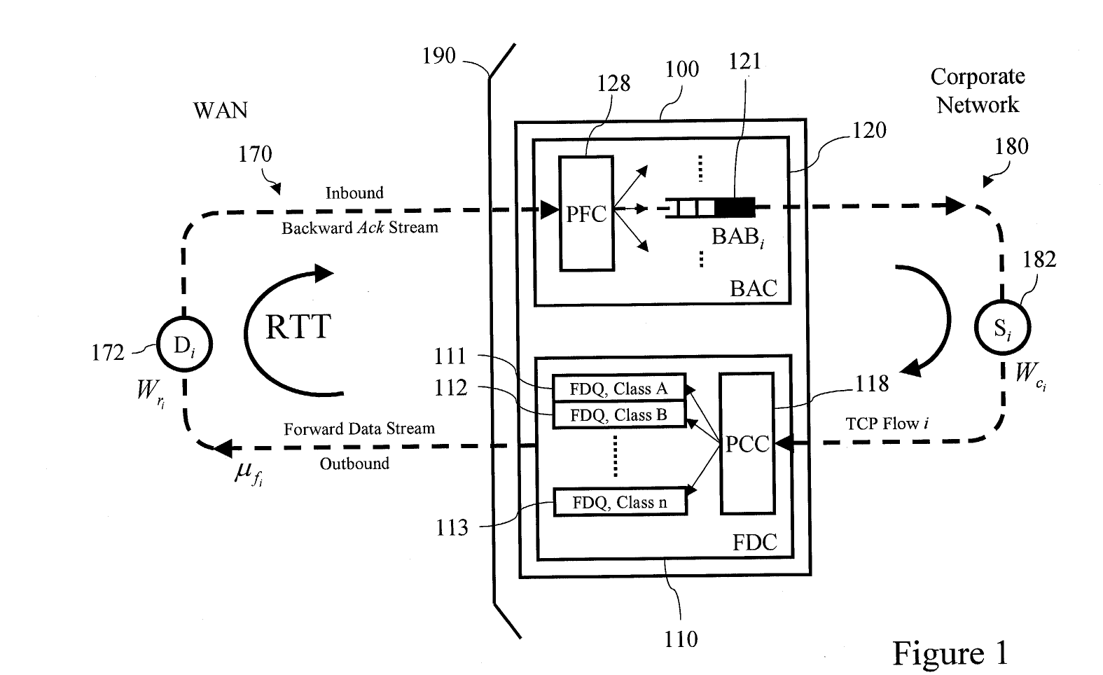

The block diagram of FIG. 1 schematically illustrates a typical TCP bandwidth management system according to the prior art. In this system, TCP-unaware modules must be employed or TCP-aware add-on schemes may be used in addition. FIG. 1 serves to depict the basic system in which a TCP traffic bandwidth management device operates between a LAN (Local Area Network) and a WAN (Wide Area Network) for bandwidth management of the two in pursuit of efficient use of network bandwidth.

A bandwidth management system 100 installed at the edge 190 of a corporate network 180 is responsible for management of corporate access to a WAN 170, for example, the Internet. The access, of course, involves both inbound and outbound communication traffic from the viewpoint of the corporate network 180. In the following paragraphs, the outbound direction is defined as carrying the information stream from a source (such as in the corporate network 180) forward onto a destination (such as in the external WAN 170) and the inbound as carrying the backward stream.

On some occasions, the inbound traffic will be heavier than the outbound traffic due to corporate users' access to various information sources over the Net. On other occasions when, for example, the corporate network 180 is a service site that provides information to users coming in from over the Net, the outbound traffic will be heavier.

The bandwidth management system 100 includes a forward data controller (FDC) 110 and a backward Ack controller (BAC) 120. BAC 120 allocates a backward Ack bucket (BAB) for each passing TCP flow. Each traffic class has its corresponding FDQ (forward data queue) while each TCP flow has its corresponding BAB. Because a traffic class often has a mixed set of TCP flows within itself, an FDQ is therefore correspond to several BABs simultaneously. For example, each of the FDQs 111, 112, . . . and 113 in FDC 110 corresponds to its bandwidth traffic class. Packets of the data flow generated from TCP senders in the corporate network 180 are classified into their corresponding FDQs by the per-class classifier (PCC) 118. In this generalized example, FDQs in FDC 110 operate under a pure queuing scheme. Data in each FDQ waits in a straight-forward queued schedule to be sent out under control of certain TCP-unaware scheme.

The system of FIG. 1 illustrates a source Sᵢ in the corporate network 180 initiating a TCP flow i for transmission to a destination Dᵢ in the WAN 170. Outbound packets in a forward data stream are queued in the FDQs 111-113 until scheduled by the class-based queuing (CBQ) scheme for send out. The destination Dᵢ for this TCP transmission acknowledges each successful received data packet by replying instantly an inbound and backward Ack via the WAN 170. The incoming Acks for a certain TCP flow are stopped in a corresponding one of the backward Ack buckets in BAC 120. BAC 120 has a number of Ack buckets 121, which are used for queuing Acks of, for example, flow i classified by the per-flow classifier (PFC) 128 for temporarily holding the Ack sent back by the destination Dᵢ before it is finally relayed to the original sender Sᵢ in the corporate network 180. Note that for conventional bandwidth management systems, the BAC 120 is optional. In other words, in some conventional systems, the backward Acks from the destination Dᵢ may be relayed directly back to the source Sᵢ in the corporate network.

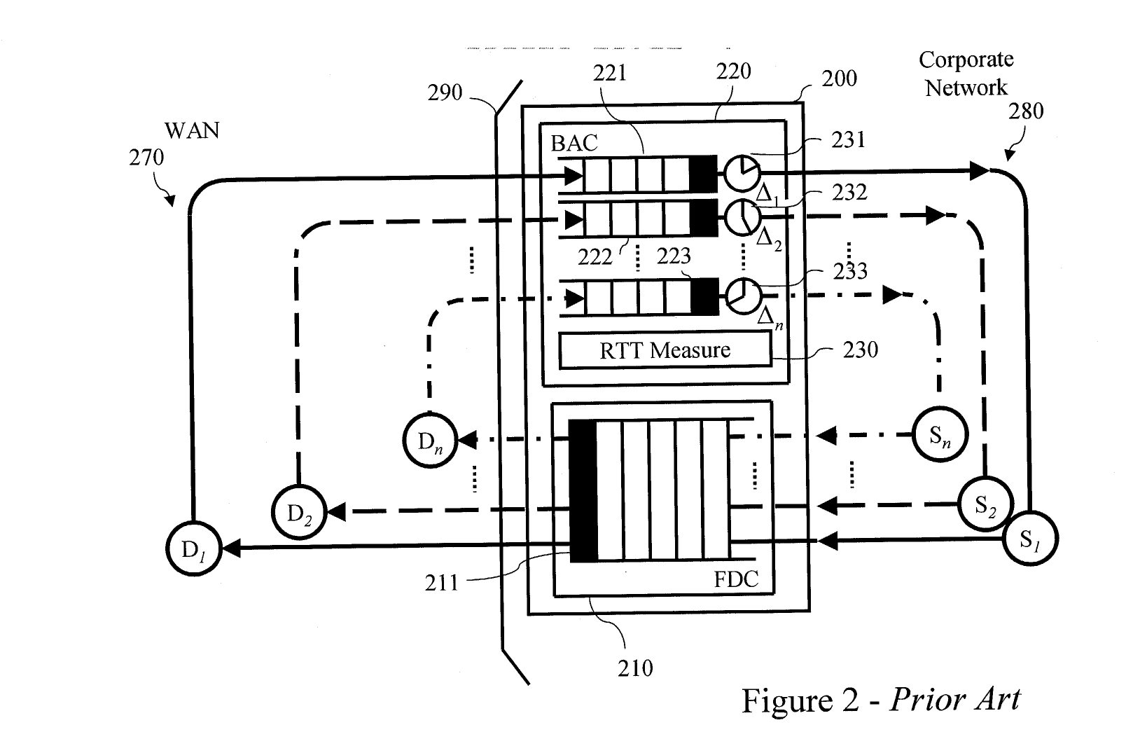

FIG. 2 is a model of a TCP bandwidth management system employing the conventional TCR scheme. This prior-art model is included herein so that the method and apparatus of the present invention may be compared with it in order to better describe the invention. Note that a typical TCR-based bandwidth management system seeks to enhance the functionality of the backward Ack controller, BAC 220 of FIG. 2. This is done by employing a round-trip time measurement module 230 to obtain BDP approximations and then shrinking the window size in the Acks. As a result of this window sizing, queuing in FDC 210 and BAC 220 can be minimized. The conventional TCR scheme further employs Ack-pacer 231, 232, . . . and 233 that cooperate with BABs 221, 222, . . . and 223 to release Acks of each TCP flow at fixed intervals. The spacing time interval between consecutive Acks for a flow i, as denoted by Δᵢ in the drawing, is calculated simply by dividing the data packet size MSSᵢ with the target bandwidth μ_{f}_{ᵢ} (MSSᵢ/μ_{f}_{ᵢ}). Such a system suffers at least two disadvantageous side effects due to the window-sizing action.

First, the bandwidth managed by a typical TCR-based system is significantly reduced further in response to the situation of packet loss over the WAN because window sizes in Acks of the TCR-governed flows have already been shrunk. Because of this window=shrinking scheme, a TCP source shrinks the already-shrunk window further whenever a packet loss occurs. Such double shrinking of window size leads to extra performance degradation. Secondly, under certain conditions when the configured BDP for certain flows are smaller than about five packets, due to the fact that the number of packets allowed onto the network pipeline becomes correspondingly few, once a packet loss situation occurs, the receiver very likely can not generate sufficient number of Acks to trigger the Triple Duplicate Ack (TDA) event. In this case, the sender is forced to re-send the lost packets only after the Retransmission Time Out (RTO) signal is issued. The problem is that many of the BSD OS versions have a RTO event trigger time of at least 500 ms (often more than 1,000 ms). This severely slows down the sender re-send mechanism when a packet loss situation arises, and the bandwidth is wasted seriously as a result.

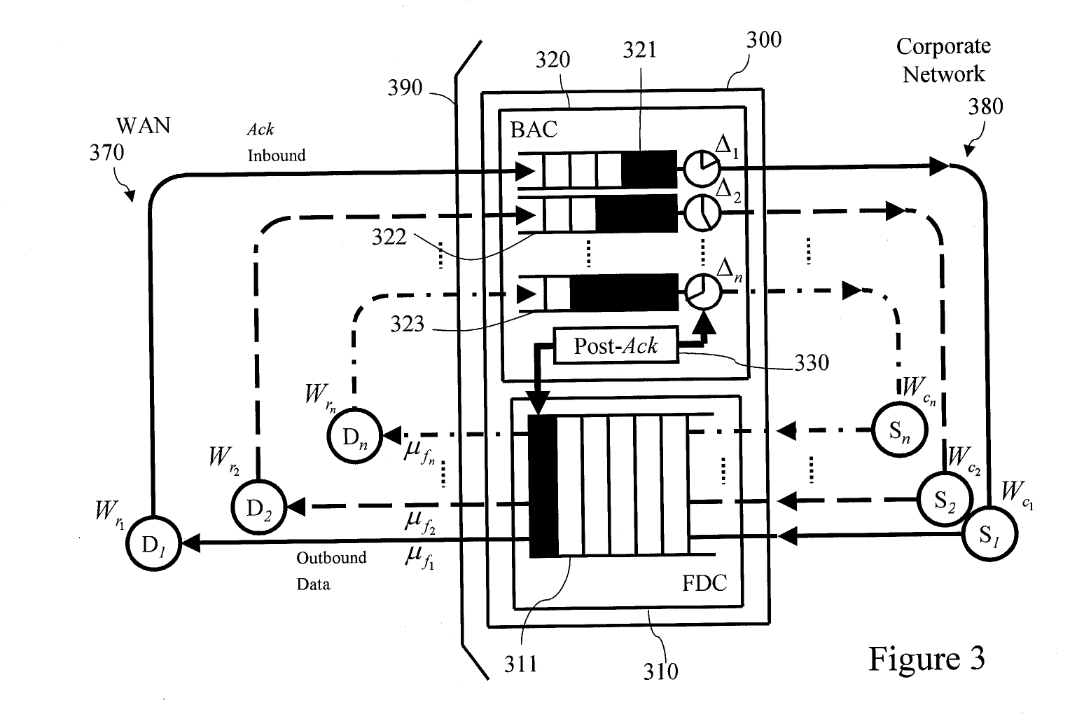

FIG. 3 illustrates a model of a TCP bandwidth management apparatus employing the post-acknowledgement control scheme in accordance with a preferred embodiment of the present invention. Note, for convenience, that the FDC 310 as incorporated in the embodiment only shows one queue, FDQ 311, which corresponds to a certain bandwidth class set by the network administrator. TCP flows classified into FDQ 311 have their corresponding BABs 321, 322, . . . ,323 in the BAC 320. The bandwidth management apparatus 300 may be installed at the edge 390 of a corporate network 380. It is responsible for management of corporate access to a WAN 370, for example, the Internet. The accesses, as comprehensible, are bi-directional involving both inbound and outbound communication traffic from the viewpoint of the corporate network 380. The inbound and outbound traffics may not be balanced as is normally the case. The weight depends on the access requirements of the corporate network involved in the system. In other words, in some cases, inbound traffic may be heavier than outbound, but in others, the reverse is true. However, control over the traffic as implemented by the apparatus and method in accordance with the preferred embodiment of the invention is, in general, applied on the outbound traffic only.

The bandwidth management apparatus 300 comprises (1) a forward data controller FDC 310 having one PCC 118 (omitted in FIG. 3) and several FDQs, such as FDQ 311, (2) a backward Ack controller BAC 320 consisting of several sets of backward Ack buckets BAB, with one set contains BAB 321, 322, . . . and 323 that correspond to the flows mixed in the FDQ 311, and (3) a post-Ack control machine 330. The FDQ 311 in FDC 310 has queuing space of a number of buffer registers for queuing outbound data for users in the corporate network 380. Note, again, that FDQ 311 in this described embodiment is one of the FDQs within an FDC, with several BAB in the BAC mapping to this FDQ 311, as is clearly illustrated in the drawing. All data packets originating from sources S₁, S₂, . . . Sₙ in the corporate network 380 and to be sent to their respective destinations D₁, D₂, . . . , Dₙ spread in the exterior WAN 370 are classified into their corresponding FDQ, the FDQ 311, by the PCC 118. In an embodiment, these mixed packets can be sent in a straight-forward first-come-first-served basis. Such a FDQ scheme reduces complexity in hardware implementation. The BAC 320 contains individually separate queues (BAB) for the passing TCP Ack flows from Dᵢ to Sᵢ in the reverse direction. In a preferred embodiment of the invention, the total number of buckets in the BAB 320 should be sufficiently large to accommodate the maximum number of TCP traffic sources that might access WAN 380 simultaneously. In the case of the embodiment of FIG. 3, a total of at least n Ack buckets 321, 322, . . . , 323 are necessary for the n sources S₁, S₂, . . . Sₙ in the corporate network 380.

It should be emphasized here that, unlike the conventional TCR, which approaches BDP by measuring RTT of a flow and then rewrites the window size parameter in TCP Acks, the concept of post-Ack control as taught by the present invention can be considered as an on-off variant of Ack-pacing that implement precise control of the on and off status of Ack-pacing. When Ack-pacing is on, the Acks of each TCP connection are uniformly released from its BAB to the Sᵢ; when Ack-pacing of a TCP flow is off, the uniformly-releasing is stopped.

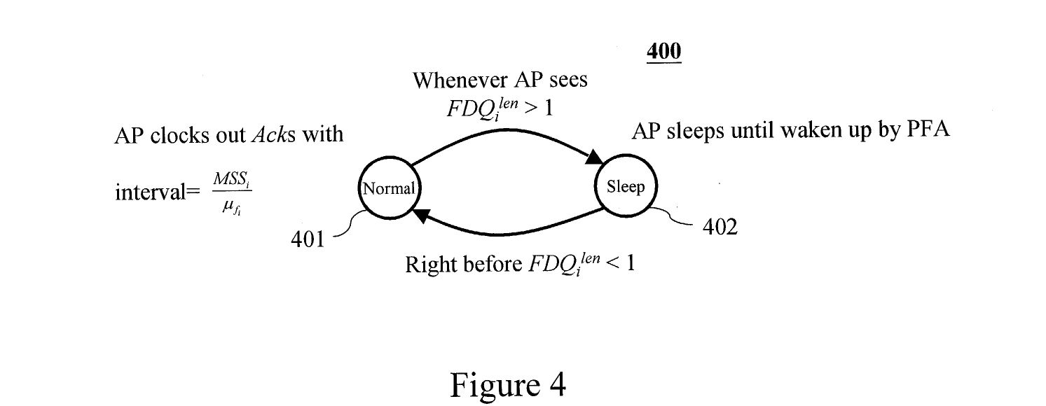

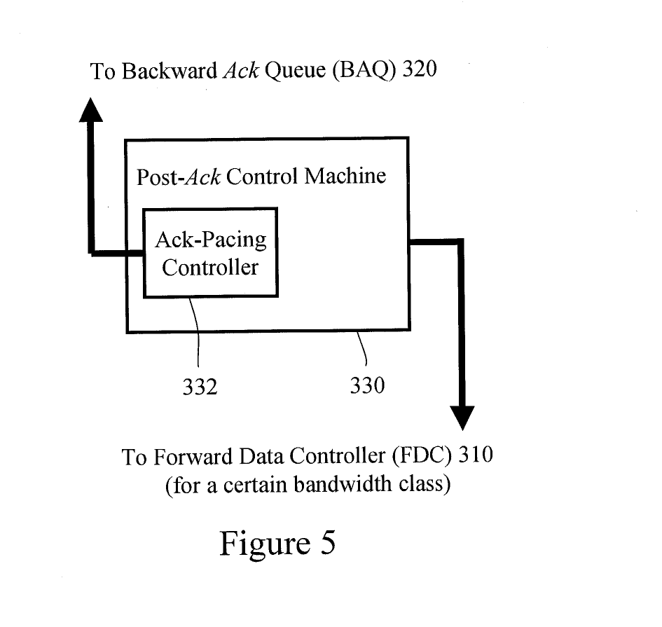

FIG. 5 is a block diagram of an embodiment of the post-Ack control machine for implementing the post-acknowledgement control scheme of the bandwidth management apparatus of the invention. The post-Ack control machine 330 comprises an Ack-pacing controller (APC) 332. This APC 332 is responsible for determining when each of the backward Acks issued by the destinations D₁, D₂, . . . , Dₙ spread over WAN 370 may be uniformly released back to their corresponding sources S₁, S₂, . . . , Sₙ in the corporate network 380. New data can be filled in the FDQ 311 only after the Acks in BABs 321, 322, . . . 323 are released, triggering the TCP sources to fill the FDQ. A post-acknowledgement algorithm is employed to implement the determination of the on and off of these uniform releases. This algorithm is based on the pre-programmed behavioral characteristics of a state machine as outlined in FIG. 4.

As is illustrated in FIG. 4, the post-acknowledgement state machine 400 is a two-state state machine. In a preferred embodiment of the invention, one state machine may be maintained for each data flow. The two states include a normal state 401 and a sleep state 402. In normal state 401, the APC 332 is allowed to clock out Acks in Ack queues 321, 322, . . . , 323 with intervals of MSSᵢ/μ_{f}_{ᵢ} between successive releases, wherein MSSᵢ is the maximum segment size of flow i, and μ_{f}_{ᵢ} is the targeted flow rate of flow i.

On the other hand, in sleep state 402, the APC 332 sleeps. While sleeping, the APC 332 does not clock out any Ack into the corporate network 380. It resumes to normal state only when the per-flow accounting (PFA) mechanism of the APC 332 wakes it up. The PFA continuously monitors the queue length occupancy of each flow mixed in the FDQ. The “wake up” occurs right before the condition FDQᵢ^{len}<1 becomes true. This condition means that the PFA has discovered that i has emptied its packet queue in the forward direction at least partially and become not fully queued (FDQ<1). Under this condition the APC 332 may continue its operation of clocking out Acks back into the corporate network 380 from BABᵢ of a flow i so as to trigger source Sᵢ to fill the FDQ instantly.

In contrast, the state machine of FIG. 4 enters sleep mode whenever the APC 332 sees the condition FDQᵢ^{len}>1. This condition means that the APC 332 has discovered that flow i has began building up its queue length in the forward direction (FDQ>1). Under this situation, the state machine immediately goes into sleep mode from normal mode.

In summary, the method of post-acknowledgement control scheme employed by the bandwidth management apparatus of the present invention for controlling TCP traffic is essentially “delaying” the return of Acks back to the sender. This delay is achieved by queuing of the Acks returned by the TCP destination, and the amount of delay is determined by the post-Ack control machine based on the conditions of the entire network system, including the corporate network 380 and the exterior WAN 370.

The idea, in a sense, is like dragging the tail of a pacing column, much like the tail of a cow, which means the control of pacing is from the rear. In another sense, the idea can be considered as redoing the inevitable queuing of data flow in the process of a TCP transmission from the forward end to the backward end. In other words, according to the present invention, the TCP data flow queued at the forwards end is effectively replaced by the TCP Ack queue at the backward end. This allows the forward data queue at the forward direction to be reduced to a minimum. As a result, the buffer latency is also drastically reduced.

Since a TCP Ack packet has a size of only 64 bytes as compared to a typical MTU (maximum transfer unit) data packet of 1,500 bytes, the effort to queue the Ack is much easier than to queue the data, i.e., from the perspective of buffer space requirement. In this regard, the buffer size reduction is drastic, more than 95% (1−(64/1500)=0.957).

Because of the fact that controlling TCP traffic via the post-acknowledgement control scheme as disclosed by the present invention does not involve the shrinking of the window size of a TCP flow, as determined by an estimated BDP that is calculated based on the measured RTT, the scheme of the present invention is therefore less independent on the operating system used for implementing the TCP sources. The method and apparatus of the invention is therefore virtually OS-independent.

Thus, the method and apparatus of the invention for bandwidth management of TCP traffic employing post-acknowledgement control is advantageous in that it is able to perform efficiently even encountering packet loss over the network. This is due primarily to the fact that the apparatus and method of the invention do not shrink the window size in TCP Acks. Also, since it is the TCP acknowledgement information that is buffered in queues, the buffer size requirement can be drastically reduced. Further, the post-acknowledgement control scheme of the invention is operating system-independent. The bandwidth management policy as set up is not subject to performance characteristics alteration due to the use of different operating systems. Users have the freedom of bandwidth management policy design without concern of whatever operating system is to host the management scheme.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An apparatus for bandwidth management of TCP traffic on a communications network, said apparatus comprising:
a forward data controller having at least one queue for queuing outbound data of said TCP traffic; and
a backward Ack controller having a post-acknowledgement control machine, and a plurality of queues for queuing inbound Acks of said TCP traffic, said post-acknowledgement control machine including an Ack-pacing controller for controlling said queuing of said backward Ack bucket, said Ack-pacing controller releasing each of said inbound Acks queued in said backward Ack bucket to the sender of said outbound data responsive to determining that said forward data queue being at least partially emptied by sending said queued outbound data to the receiver of said outbound data.

2. The apparatus of claim 1, wherein said at least one queue of said forward data controller further comprises a plurality of buffer registers organized in a single queue.

3. The apparatus of claim 1, wherein the total number of said plurality of queues of said backward Ack controller are not less than the maximum number of senders sending said outbound data simultaneously.

4. The apparatus of claim 1, wherein said communications network is the Internet.

5. The apparatus of claim 1, wherein said communications network is a corporate network.

6. The apparatus of claim 1, wherein said Ack-pacing controller of said post-acknowledgement control machine is a state machine, said state machine operates in at least two modes including a normal mode and a sleep mode, said state machine changes from said sleep state to said normal state responsive to said forward data queue being at least partially emptied, and changes from said normal state to said sleep state when said forward data queue is full.

7. An apparatus for bandwidth management of TCP traffic on a communications network, said apparatus comprising:
a forward data controller having at least one queue for queuing outbound data of said TCP traffic; and
a backward Ack controller having a post-acknowledgement control machine and a plurality of queues for queuing inbound Acks of said TCP traffic, said post-acknowledgement control machine including a state machine, said state machine operates between at least two modes including a normal mode and a sleep mode, said state machine changing from said sleep state to said normal state responsive to said forward data queue being at least partially emptied, and changing from said normal state to said sleep state when said forward data queue is full, and said post-acknowledgement control machine controlling said queuing of said backward Ack bucket by thereafter releasing each of said inbound Acks queued in said backward Ack bucket to the sender of said outbound data in said normal mode.

8. The apparatus of claim 7, wherein said at least one queue of said forward data controller further comprises a plurality of buffer registers organized in a single queue.

9. The apparatus of claim 7, wherein the total number of said plurality of queues of said backward Ack controller are not less than the maximum number of senders sending said outbound data simultaneously.

10. The apparatus of claim 7, wherein said communications network is the Internet.

11. The apparatus of claim 7, wherein said communications network is a corporate intranet.

12. An apparatus for bandwidth management of TCP traffic on Internet, said apparatus comprising:
a forward data controller having at least one queue of a plurality of buffer registers for queuing outbound data of said TCP traffic; and
a backward Ack controller having a post-acknowledgement control machine and a plurality of queues each having a plurality of buffer registers for queuing inbound Acks of said TCP traffic, said post-acknowledgement control machine including a state machine, said state machine operates between at least two modes including a normal mode and a sleep mode, said state machine changing from said sleep state to said normal state responsive to said at least one queue of said forward data controller being at least partially emptied, and changing from said normal state to said sleep state when said at least one queue of said forward data controller is full, and said post-acknowledgement control machine controlling said queuing of said backward Ack controller by thereafter releasing each of said inbound Acks queued in said backward Ack controller to the sender of said outbound data in said normal mode.

13. A method for bandwidth management of TCP traffic on a communications network employing a post-acknowledgement bandwidth management apparatus having a forward data controller for queuing outbound data of said TCP traffic, a backward Ack controller for queuing inbound Acks of said TCP traffic, and a post-acknowledgement control machine; said method comprising the steps of:
a) queuing said inbound Acks of said TCP traffic in backward Ack buckets of said backward Ack controller; and
b) releasing each of said inbound Acks queued in said backward Ack bucket back to the sender of said outbound data responsive to said forward data queue being at least partially emptied by sending said queued outbound data to the receiver of said outbound data.

14. The method of claim 13, wherein said step a) of queuing inbound Acks of said TCP traffic comprises a further step of queuing said Acks into a single queue.

15. The method of claim 13, wherein said step a) of queuing inbound Acks of said TCP traffic comprises queuing said Acks in backward Ack buckets of said backward Ack controller organized into a plurality of queues not less than the maximum number of senders sending said outbound data simultaneously.

16. The method of claim 13, wherein said communications network is the Internet.

17. The method of claim 13, wherein said communications network is a corporate intranet.
